(19) United States
(12) Patent Application Publication
(10) Pub. No.: US 2005/0119146 A1
(43) Pub. Date: Jun. 2, 2005

(54) Surfactant composition containing amphiphilic copolymer

(76) Inventor: Klein A. Rodrigues, Signal Mountain, TN (US)

Correspondence Address: NATIONAL STARCH AND CHEMICAL COMPANY, P.O. BOX 6500, BRIDGEWATER, NJ, 08807-3300, US

(21) Appl. No.: 10/996,268

(22) Filed: Nov. 23, 2004

Related U.S. Application Data
(63) Continuation-in-part of application No. 10/464,365, filed on Jun. 17, 2003.

(51) Int. Cl. C11D 1/00

(52) U.S. Cl. 510/224

(57) ABSTRACT

A concentrated surfactant composition containing an amphiphilic copolymer. The addition of the polymer to the concentrated surfactant changes the physical properties of the concentrated surfactant, making it easier to process. The cleaning properties of anionic and amphoteric surfactants in the dilute phase of the wash solution are improved by combining them with these amphiphilic copolymers.

### CROSS REFERENCE TO RELATED APPLICATIONS

The present application is a continuation-in-part of U.S. application Ser. No. 10/464,365 filed 17 Jun. 2003.

### BACKGROUND OF THE INVENTION

1. Technical Field

The present invention relates to a surfactant composition containing an amphiphilic copolymer. More particularly, the present invention is directed towards a surfactant composition having a blend of one or more surfactants and one or more amphiphilic copolymers that perform synergistically with the surfactant in cleaning.

2. Background Information

Cleaning compositions such as detergents, shampoos, and cleaners include one or more surfactants or soaps for allowing the removal of organic material from a substrate in an aqueous environment. These surfactants are typically sold as concentrates that often have to be melted for processing into final commercial products. The cleaning compositions can contain other ingredients, such as builders, enzymes, polymers and hydrotropes that provide beneficial product and end-use properties.

Hydrophobically modified water-soluble polymers are used in laundry and cleaning compositions, and are useful for soil release properties and in preventing soil redeposition. U.S. Pat. No. 5,723,434 describes the use of a hydrophilic polymer backbone having a hydrophobic pendant group in isotropic liquid detergents. The polymer helps improve the clarity of the isotropic liquid detergent. U.S. patent Publication No. 2003/0162679 describes hydrophobically modified copolymers for use in increasing the dissolution rates of surfactants into aqueous systems, especially from single-dose tablets, pouches, and sachets. These polymers are also useful in suspending hydrophobic soils in autodish and hard surface cleaning applications. The hydrophobically modified copolymers can act as corrosion inhibitors for aluminum in a variety of applications.

U.S. Pat. No. 5,789,511 describes the synthesis of styrene or substituted styrene monomer with a carboxylated monomer to produce a hydrophobically modified water-soluble polymer. These polymers provide good soil release properties and are useful in cleaning compositions for fabrics and hard surfaces.

U.S. Pat. No. 6,337,313 describes the synthesis and use of hydrophobically modified copolymers with hydrophilic backbones and at least one hydrophobic moiety in a textile manufacturing or treating process. U.S. Pat. No. 6,790,818 describes the use of hydrophobic alkylene oxide copolymers in hand dish applications.

U.S. Pat. No. 5,886,076 describes solution polymerization processes for producing styrene copolymers from styrene and a carboxylate monomer. The styrene copolymers are useful in cleaning composition having an alcohol ethoxylate surfactant and 1 to 10 percent of the copolymer. The polymer provides good soil release properties and can act synergistically with non-ionic alcohol ethoxylate surfactants. The '076 does not suggest the use of other surfactants such as anionic or amphoteric surfactants.

### SUMMARY OF THE INVENTION

The present invention is directed towards a concentrated surfactant composition containing one or more surfactants and one or more amphiphilic copolymers. By combining concentrated surfactants with amphiphilic copolymers, their processing properties are improved, thereby decreasing both time and expense in manufacturing. In this respect, processing properties are improved in that the melting point of the surfactant is lowered. Thus the surfactant does not need to be stored hot or to be melted before use.

It has now been found that amphiphilic copolymers have a synergistic cleaning effect with anionic and/or amphoteric surfactants, i.e., interfacial tension between these surfactants is reduced in the presence of these polymers leading to better cleaning properties in wash solutions. These amphiphilic polymers effectively change the physical properties of concentrated surfactants, making the surfactants easier and faster to process into useful end-products. The modified concentrated surfactant composition of the present invention shows an increase in the rate of surfactant dissolution and a lower melting point of the surfactant, thereby improving ease of handling. The polymers of the present invention also improve the cleaning properties of anionic and amphoteric surfactants in the dilute phase of the wash liquor.

Generally speaking, an amphiphilic molecule is one having a single water-soluble polar head (hydrophilic) and a single water-insoluble organic ‘tail’ (hydrophobic). Examples include octyl alcohol and sodium stearate. For the purpose of the present application, the amphiphilic polymer is not limited to single constituents, but can have more than one water-soluble and more than one water-insoluble segment. Depending on the surfactant used in the blend of the present invention and its hydrophile-lipophile balance (‘HLB’), the balance of hydrophilic and hydrophobic constituents (the ‘amphiphilicity’) in the amphiphilic copolymer will have to be adjusted in order to maximize the benefits.

Accordingly, the present invention provides for a surfactant blend useful in cleaning compositions having at least one amphoteric and/or anionic surfactant, and from 0.1 to 10 percent by weight of at least one amphiphilic copolymer based on the weight of the surfactant; wherein the at least one amphiphilic copolymer has a synergistic cleaning effect with the at least one anionic and/or amphoteric surfactants. The present invention further provides for a concentrated surfactant composition having at least 50 percent by weight of the surfactant blend. In another embodiment, the concentrated surfactant composition includes at least 60 percent by weight of the surfactant blend. In a further embodiment the concentrated surfactant composition includes at least 70 percent by weight of the surfactant blend. In even a further embodiment the concentrated surfactant composition includes at least 75 percent by weight of the surfactant blend. In another embodiment the concentrated surfactant composition includes at least 85 percent by weight of the surfactant blend. In a further embodiment the concentrated surfactant composition of includes at least 90 percent by weight of the surfactant blend. In even another embodiment the concentrated surfactant composition includes at least 95 percent by weight of the surfactant blend.

The surfactant blend can include in one embodiment from 0.5 to 5 percent by weight of an amphiphilic copolymer based on the weight of the surfactant. This amphiphilic copolymer includes a hydrophilic backbone and at least one hydrophobic moiety. The hydrophilic backbone can include monomer units such as acrylic acid, methacrylic acid, maleic acid, maleic anhydride, itaconic acid or mixtures thereof. The hydrophobic moiety can be one or more hydrophobic monomers such as acrylate monomers, methacrylate monomers, styrene and styrene derivatives, acrylamide derivatives and alkyl acrylamide, vinyl naphthalene, butadiene or mixtures thereof. In one aspect the hydrophobic moiety includes a chain transfer agent.

Optionally, the surfactant blend can include at least one non-ionic surfactant. This non-ionic surfactant can include alcohol ethoxylates, nonophenol ethoxylates or mixtures thereof.

When the surfactant of the surfactant blend is an anionic surfactant, the anionic surfactant can be linear alkyl benzene sulfonates, alcohol ether sulfates or mixtures thereof. In one embodiment, the surfactant blend can include one or more non-ionic surfactants and one or more anionic surfactants.

The present invention further provides for a method of cleaning surfaces. This method includes contacting the surface to be cleaned with a solution having less than 1000 ppm of at least one amphiphilic copolymer formed from polymerizing at least one hydrophilic acid monomer and at least one hydrophobic moiety, and less than 1000 ppm of at least one amphoteric and/or at least one anionic surfactant. Optionally, the surface can be rinsed with water such that the surface is cleaned. The surfaces to be cleaned include dishware, floor, tiles, kitchen and bathroom surfaces, wood, hair or skin.

The surfactant used in the cleaning method can be an amine oxide surfactant. The surfactant can also be an alcohol ether sulfate.

The hydrophobic moiety portion of the amphiphilic copolymer can be, for example, lauryl methacrylate, methyl methacrylate and/or styrene. In one aspect the hydrophobic moiety is a chain transfer agent. The hydrophilic moiety portion of the amphiphilic copolymer can be, for example, acrylic acid, methacrylic acid, maleic acid, itaconic acid, sodium methallyl sulfonate, sodium allyloxybenzene sulfonate and sodium acrylamidomethyl propane sulfonate.

The present invention also provides a method for improving the solubility of a hand dishwashing composition. According to the method, the aforementioned amphiphilic copolymer is added to a hand dishwashing composition, and the hand dishwashing composition subsequently diluted. This hand dishwashing composition can include anionic or amphoteric surfactants or mixtures thereof. When the surfactant is an anionic surfactant, the anionic surfactant can be an alcohol ether sulfate. When the surfactant is an amphoteric surfactant, the amphoteric surfactant can be an amine oxide.

Accordingly, the present invention is directed towards a concentrated surfactant composition. This composition includes at least 50 percent by weight of a modified surfactant blend. The modified blend includes at least one surfactant, from about 0.1 to about 10 percent by weight of at least one amphiphilic copolymer based on the weight of the surfactant, and water.

The surfactant composition according to the present invention improves the cleaning properties of anionic and/or amphoteric surfactants in the dilute phase of the wash solution by combining them with these amphiphilic copolymers. By ‘dilute phase’ it is meant when the cleaning formulation is diluted down to end use levels and is in contact with the substrate that is being cleaned. In most cases, the surfactant and/or polymer concentration in the dilute phase is less than 1000 ppm.

### DETAILED DESCRIPTION OF THE INVENTION

The present invention is directed towards a concentrated surfactant composition containing at least one surfactant and at least one amphiphilic copolymer. It is also directed towards improving the cleaning properties of anionic and/or amphoteric surfactants in the dilute phase of the wash solution by combining them with these amphiphilic copolymers.

In one embodiment, the amphiphilic copolymers are prepared from at least one hydrophilic acid monomer and at least one hydrophobic moiety. The acid monomer can be a polymerizable carboxylic or sulfonic acid containing monomer. Examples of polymerizable carboxylic or sulfonic acid containing monomers include acrylic acid, methacrylic acid, ethacrylic acid, α-chloro-acrylic acid, α-cyano acrylic acid, β-methyl-acrylic acid (crotonic acid), α-phenyl acrylic acid, β-acryloxy propionic acid, sorbic acid, α-chloro sorbic acid, angelic acid, cinnamic acid, p-chloro cinnamic acid, β-styryl acrylic acid (1-carboxy-4-phenyl butadiene-1,3), itaconic acid, maleic acid, citraconic acid, mesaconic acid, glutaconic acid, aconitic acid, fumaric acid, tricarboxy ethylene, 2-acryloxypropionic acid, 2-acrylamido-2-methyl propane sulfonic acid, vinyl sulfonic acid, sodium methallyl sulfonate, sulfonated styrene, allyloxybenzene sulfonic acid, maleic acid, and maleic anhydride. Moieties such as maleic anhydride or acrylamide that can be derivatized to an acid containing group can also be used. Combinations of acid containing hydrophilic monomers can also be used. In one aspect the acid containing hydrophilic monomer is acrylic acid, maleic acid, itaconic acid or mixtures thereof.

The hydrophilic portion of the polymer can also be generated from a water soluble chain transfer agent. Water soluble chain transfer agents that can be used include short chain mercaptans, e.g., 3-mercaptopropionic acid, 2-mercaptoethanol and so forth, as well as phosphorus-based chain transfer agents such as phosphoric acid and sodium hypophosphite.

The at least one hydrophobic moiety can be prepared from at least one hydrophobic monomer, chain transfer agent and/or surfactant. Useful hydrophobic monomers include ethylenically unsaturated monomers with saturated or unsaturated alkyl, hydroxyalkyl, alkylalkoxy group, arylalkoxy, alkarylalkoxy, aryl and aryl-alkyl group, alkyl sulfonate, aryl sulfonate, siloxane and combinations thereof. Useful chain transfer agents include those having from 3 to 24 carbon atoms. Examples of useful chain transfer agents include mercaptan, amine, alcohol, α-olefin sulfonate and combinations thereof. Examples of useful surfactants include alcohol ethoxylate, alkyl phenol ethoxylate and alkyl aryl sulfonate.

Examples of hydrophobic monomers include styrene, α-methyl styrene, methyl methacrylate, methyl acrylate, 2-ethylhexyl acrylate, octyl acrylate, lauryl acrylate, stearyl acrylate, behenyl acrylate, 2-ethylhexyl methacrylate, octyl methacrylate, lauryl methacrylate, stearyl methacrylate, behenyl methacrylate, 2-ethylhexyl acrylamide, octyl acrylamide, lauryl acrylamide, stearyl acrylamide, behenyl acrylamide, propyl acrylate, butyl acrylate, pentyl acrylate, hexyl acrylate, 1-vinyl naphthalene, 2-vinyl naphthalene, 3-methyl styrene, 4-propyl styrene, t-butyl styrene, 4-cyclohexyl styrene, 4-dodecyl styrene, 2-ethyl-4-benzyl styrene, and 4-(phenyl butyl)styrene. Combinations of hydrophobic monomers can also be used.

The hydrophobic moieties can be selected from siloxanes, aryl sulfonate, and saturated and unsaturated alkyl moieties optionally having functional end groups, wherein the alkyl moieties have from 5 to 24 carbon atoms. In another aspect the alkyl moieties have from 6 to 18 carbon atoms. In a third aspect the alkyl moieties have from 8 to 16 carbon atoms. The hydrophobic moieties can optionally be bonded to the hydrophilic backbone by means of an ethylene oxide unit having from 1 to 50 ethylene oxide groups. The hydrophobic moiety can also be incorporated into the amphiphilic copolymer through the use of surfactant molecules. For example, hydrophilic acid monomers can be grafted onto a surfactant backbone. Alternatively, a surfactant can be attached to a polymerizable unit such as an ester of methacrylic acid, a C₁₂₋₂₂ alkoxy poly(ethyleneoxy)ethanol having about twenty ethoxy units, or a C₁₆₋₁₈ alkoxy poly(ethyleneoxy)ethanol having about twenty ethoxy units. This polymerizable unit can then be incorporated into the polymer.

Alternatively or additionally, the hydrophobic moiety can be introduced into the amphiphilic copolymer in the form of a chain transfer agent. In one aspect, the chain transfer agent can have from 3 to 24 carbon atoms. In another aspect the chain transfer agent can have from 3 to 14 carbon atoms. In a third aspect the chain transfer agent can have from 3 to 12 carbon atoms.

Useful chain transfer agents include mercaptans or thiols, amines, alcohols, or α-olefin sulfonates. A combination of chain transfer agents can also be used. Mercaptan chain transfer agents useful in this invention include organic mercaptans having at least one —SH or thiol group and that are classified as aliphatic, cyclo-aliphatic or aromatic mercaptans. The mercaptans can contain other substituents in addition to hydrocarbon groups, such as carboxylic acid groups, hydroxyl groups, ether groups, ester groups, sulfide groups, amine groups and amide groups. Examples of suitable mercaptans include methyl mercaptan, ethyl mercaptan, butyl mercaptan, mercaptoethanol, mercaptopropanol, mercaptobutanol, mercaptoacetic acid, mercaptopropionic acid, thiomalic acid, benzyl mercaptan, phenyl mercaptan, cyclohexyl mercaptan, 1-thioglycerol, 2,2′-dimercaptodiethyl ether, 2,2′-dimercaptodipropyl ether, 2,2′-dimercaptodiisopropyl ether, 3,3′-dimercaptodipropyl ether, 2,2′-dimercaptodiethyl sulfide, 3,3′-dimercaptodipropyl sulfide, bis(β-mercaptoethoxy)methane, bis(β-mercaptoethylthio)methane, ethane dithio-1,2, propane dithiol-1,2, butane dithiol-1,4, 3,4-dimercaptobutanol-1, trimethylolethane tri(3-mercaptopropionate), pentaerythritol tetra(3-mercapto-propionate), trimethylolpropane trithioglycolate, pentaerythritol tetrathio-glycolate, octanethiol, decanethiol, dodecanethiol and octadecylthiol. In one embodiment the mercaptan chain transfer agent is octanethiol, dodecanethiol or combinations thereof.

Useful chain transfer agent can be amine compounds such as methylamine, ethylamine, isopropylamine, n-butylamine, n-propylamine, iso-butylamine, t-butylamine, pentylamine, hexylamine, benzylamine, octylamine, decylamine, dodecylamine, and octadecylamine. In one aspect the amine chain transfer agent is isopropylamine, docylamine or combinations thereof.

Alcohol or hydroxyl chain transfer agents useful in the present invention include methanol, ethanol, isopropanol, n-butanol, n-propanol, iso-butanol, t-butanol, pentanol, hexanol, benzyl alcohol, octanol, decanol, dodecanol, and octadecanol. In one aspect the alcohol chain transfer agent is isopropanol, dodecanol or combinations thereof.

Other hydrophobic monomers suitable for producing the amphiphilic copolymers of the present invention include α-olefin sulfonates. Examples of such sulfonates include C₈-C₁₈ α-olefin sulfonates such as Bio-Terge® AS-40 (available from Stepan Company, Northfield, Ill.), Hostapur OS liquid (available from Clariant International Ltd., Muttenz, Switzerland) and Witconate AOS (available from Witco Corp, Greenwich, Conn.).

The amphiphilic copolymers can be prepared by processes known in the art, such as those disclosed in U.S. Pat. Nos. 5,147,576, and 5,650,473. In one embodiment the amphiphilic copolymers are prepared using conventional polymerization procedures but employing a process wherein the polymerization is carried out in the presence of a suitable cosolvent. The ratio of water to cosolvent is carefully monitored and maintained in order to keep the polymer in a sufficiently mobile condition as it forms and to prevent unwanted homopolymerization of the hydrophobic monomer and subsequent undesired precipitation thereof.

The amphiphilic copolymers of the present invention can be cationic. Cationic amphiphilic copolymers include copolymers having a hydrophobe and an amide-functional monomer with the amide functionality on the polymer backbone, in side chains, or a combination thereof. Amide monomers useful in the present invention do not have an amine linkage in the side chain. While any polymerizable amide-functional monomer may be used, substituted amides are preferred. Substituted amides are known to push the electron balance toward the amide nitrogen, making it slightly more basic. In one aspect the substituted amides include mono- and di-substituted amides such as mono-alkyl amide, mono-alkyl acrylamide, N,N-dialkyl acrylamide, and N,N-dialkyl amide. In another aspect the amide monomers are N,N-dimethyl acrylamide, N,N-diethyl acrylamide, N-isopropyl acrylamide and acryloyl morpholin. A mixture of amide monomers can also be used. In one embodiment, the amide monomer(s) make up at least 1 mole percent of the amphiphilic polymer. In another embodiment, the amide monomer(s) make up at least 5 mole percent of the polymer. In a further embodiment, the amide monomer(s) make up at least 10 mole percent of the amphiphilic copolymer. In even another embodiment, the amide monomer(s) make up at least 25 mole percent of the copolymer. Amide monomer levels greater than 40 mole percent, greater than 50 mole percent and even greater than 75 mole percent can be advantageous in some circumstances depending on the intended end-use.

Copolymers of amino acids such as a copolymer of aspartic acid and sodium aspartate, as disclosed in U.S. Pat. No. 5,981,691 are useful. These polymers contain amide functionality in the backbone and are available from Folia, Inc., Birmingham, Alabama as Reactin™ AS 11. These copolymers also have imide functionality. This imide functionality can be reacted with an amine reagent such as diethanol amine to form a polymer with amide side chains.

Non-ionic amphiphilic copolymers include copolymers having a hydrophobe and a monomer such as acrylamide, substituted acrylamide, vinyl pyrrolidone, acryloyl morpholine and vinyl imidazoline.

The amphiphilic copolymer of the present invention complexes heavy metal ions in the manufacturing or treating of textiles. For example, the amphiphilic copolymers help stabilize hydrogen peroxide in the bleaching process, reduce scale and prevent deposition of heavy metal ions such as iron, calcium and magnesium during the scouring, desizing, mercerising and bleaching processes. In addition, the amphiphilic copolymers prevent redeposition of particulate soils onto the textiles.

The amount of hydrophobic moieties depends on the size of the hydrophobic group. If the hydrophobic group is relatively small, such as methyl methacrylate or styrene, the hydrophobic moiety can be present at up to 90 mole percent. If the hydrophobic group is large, such as a C₁₈ methacrylate, then lesser amount of hydrophobic moiety is required. Generally an amphiphilic copolymer containing 0.5 to 25 mole percent of the hydrophobic monomer is used.

The amphiphilic copolymers of this invention can be used to modify concentrated surfactant phases. By concentrated surfactant phases, it is meant that the surfactant is greater than 50% by weight of the solution. Preferably the surfactant is greater than 60% of the solution and most preferably the surfactant is greater than 70% of the solution. Surfactants useful in this aspect of the invention include cationic, anionic, non-ionic and amphoteric surfactants.

Anionic surfactants include, for example, C₈-C₂₀ alkylbenzenesulfonates, C₈-C₂₀ alkanesulfonates, C₈-C₂₀ alkylsulfates, C₈-C₂₀ alkylsulfosuccinates, and C₈-C₂₀ sulfated ethoxylated alkanols.

Cationic surfactants include, for example, dieicosyldimethyl ammonium chloride; didocosyldimethyl ammonium chloride; dioctadecyldimethyl ammonium chloride; dioctadecyldimethyl ammonium methosulfate; ditetradecyldimethyl ammonium chloride and naturally occurring mixtures of the above fatty groups, e.g. di(hydrogenated tallow)dimethyl ammonium chloride; di(hydrogenated tallow)dimethyl ammonium methosulfate; ditallow dimethyl ammonium chloride; and dioleyldimethyl ammonium chloride. In one aspect the cationic surfactants are di(hydrogenated tallow)dimethyl ammonium chloride or dioctadecyl dimethyl ammonium chloride.

Cationic surfactants also include imidazolinium compounds such as 1-methyl-1-(tallowylamido-)ethyl-2-tallowyl-4,5-dihydroimidazolinium methosulfate and 1-methyl-1-(palmitoylamido)ethyl-2-octadecyl-4,5-dihydro-imidazolinium methosulfate. Other useful imidazolinium materials are 2-heptadecyl-1-methyl-1(2-stearoylamido)-ethyl-imidazolinium methosulfate and 2-lauryl-lhydroxyethyl-1-oleyl-imidazolinium chloride.

Nonionic surfactants include, for example, from C₆-C₁₂ alkylphenol ethoxylates, C₈-C₂₀ alkanol alkoxylates, and block copolymers of ethylene oxide and propylene oxide. Optionally, the end groups of polyalkylene oxides can be blocked so that the free —OH groups of the polyalkylene oxides can be etherified, esterified, acetalized and/or aminated. Another modification involves reacting the free —OH groups of the polyalkylene oxides with isocyanates. The nonionic surfactants also include C₄-C₁₈ alkyl glucosides as well as the alkoxylated products obtainable therefrom by alkoxylation, particularly those obtainable by reaction of alkyl glucosides with ethylene oxide.

Amphoteric surfactants containing both acidic and basic hydrophilic groups can be used in the present invention. These amphoteric surfactants can be derivatives of secondary and tertiary amines, derivatives of quaternary ammonium, quaternary phosphonium or tertiary sulfonium compounds. The cationic atom in the quaternary compound can be part of a heterocyclic ring. The amphoteric surfactant preferably contains at least one aliphatic group, containing about 3 to about 18 carbon atoms. At least one aliphatic group preferably contains an anionic water-solubilizing group such as a carboxy, sulfonate, or phosphono.

The level of hydrophobicity needed in the copolymer is dependent on the HLB of the surfactants. The higher the HLB, the more hydrophobic the polymer needs to be to be effective.

The type of copolymer useful in the invention is related to the type of surfactant with which it will be combined. For example, hydrophobically modified amine polymers and other cationic polymers will affect the physical properties of cationic surfactants. Anionic surfactants may be affected by polymers having a negatively charged hydrophobic portion (anionic polymers). Both anionic and cationic copolymers may be useful with non-ionic surfactants. Non-ionic polymers may be useful with anionic, cationic and non-ionic surfactants.

The polymer may be combined with the surfactant by any means. The combination may include with the surfactant a hydrophobically modified copolymer, or a combination thereof. Since the pure surfactant generally leaves its manufacturing process at an elevated temperature, polymer could be added to the hot surfactant. The preferred method is to add the aqueous polymer solution to the molten surfactant. However, the polymer is in a dry form, and could be added as a dry solid, or could be melted prior to adding to the surfactant. The amphiphilic copolymer is present in the concentrated surfactant composition at from 0.1 to 10 weight percent, based on the weight of the surfactant, preferably from 0.5 to 5 weight percent, and most preferably from 1 to 3 weight percent based on the weight of the surfactant.

The surfactant compositions in this aspect of the present invention are concentrated and contain primarily only surfactant and amphiphilic copolymer. The surfactant could be a blend of more than one surfactant. The level of water in the system, if any is low, preferably less than 50 percent by weight, more preferably less than 40 percent by weight, even more preferably less than 30 percent by weight, more preferably less than 25 percent by weight, more preferably less than 15 percent by weight, even more preferably less than 10 percent by weight, and most preferably less than 5 percent by weight.

While not being bound by any particular theory, it is believed that the polymer changes the phase relationship of the surfactant micelle. Polymer becomes part of the micelle, and disrupts the packing of the surfactant molecules. This changes the physical properties of the surfactant micelle since there is a lower attraction between the surfactant molecules in the micelle. The lower attraction lowers the melting point of the surfactant and provides faster dissolution.

One advantage is that when one dissolves surfactants from the 100 percent active material they go through different phase transitions. Some of these phases are gels which are hard to overcome. The use of the copolymers in combination with the concentrated surfactants eliminates the gel phase and makes processing very easy. This is especially true in hand dish wash formulations, which are difficult to dilute due to gel phase formation. Solvents such as ethanol are typically used to overcome this problem. However, these solvents are volatile and can evaporate away with time. The polymers of this invention can replace these solvents at lease partially and enable the dilution of these formulations. These polymers also lower the melting point and therefore you save time and money especially in the winter time.

The net effect is that the surfactants are easier to handle, and the processing is easier and faster, enabling the soaper to save costs. Many surfactants are sold in molten form, which requires heating the surfactant during transportation and storage. The lower melting point caused by the addition of an amphiphilic copolymer to the surfactant leads to lower energy requirements and faster processing.

The surfactant composition may be used in the formulation of detergents and hard surface cleaners. The detergents and cleaners have many uses, including in shampoo, personal care products, metal cleaners, laundry and dishwash detergents, and floor cleaners. In formulations such as floor cleaners, where it is desirable to use lower amounts of surfactant for less streaking and less residual, the lower CMC allows for good performance with less surfactant, saving costs.

The present invention further provides for an improvement in cleaning performance due to the synergism between the amphiphilic copolymers and the anionic and/or amphoteric surfactants in the dilute phase. The ‘dilute phase’ refers to when the cleaning formulation is diluted down to end use levels and is in contact with the substrate to be cleaned. Typically, surfactant concentrations are less than 1000 ppm in such applications. In another embodiment, the surfactant concentrations are less than 500 ppm in the wash liquor. In even another embodiment the surfactant concentrations are less than 300 ppm in the wash liquor.

As previously noted, the amphiphilic copolymers according to the present invention have a synergistic effect with amphoteric and/or anionic surfactants in the dilute phase of the wash water. These polymers lower the interfacial tension of anionic or amphoteric surfactants and oily soils in the dilute phase of the wash liquor. As a result, improved cleaning in the dilute phase of the wash liquor occurs when using these polymers in conjunction with anionic or amphoteric surfactants. Surfactant levels in this dilute phase are typically less than 1000 ppm of the wash liquor. However, the surfactant levels can be as low as 100 ppm. The polymer level is typically less than 100 ppm in the wash liquor. However, the polymer level can be as low as 10 ppm or even lower.

Amphoteric surfactants useful in the present invention can include amine oxides, betaines, sulfobetaines and derivatives, or aliphatic and heterocyclic secondary and tertiary amines in which the aliphatic moieties have at least one water soluble anionic group. In one aspect, the amphoteric surfactants useful in the present invention are selected from amine oxide surfactants. Amine oxide surfactants include water-soluble amine oxides having one alkyl moiety of from 10 to 18 carbon atoms and 2 moieties selected from the group consisting of alkyl groups and hydroxyalkyl groups having from 1 to 3 carbon atoms; water-soluble phosphine oxides containing one alkyl moiety of from 10 to 18 carbon atoms and 2 moieties selected from the group consisting of alkyl groups and hydroxyalkyl groups containing from 1 to 3 carbon atoms; and water-soluble sulfoxides containing one alkyl moiety of from 10 to 18 carbon atoms and a moiety selected from the group consisting of alkyl and hydroxyalkyl moieties of from 1 to 3 carbon atoms. For example, the amine oxide surfactants include C₁₀-C₁₈ alkyl dimethyl amine oxides and C₈-C₁₂ alkoxy ethyl dihydroxyethyl amine oxides. Further examples of suitable amphoteric surfactants are provided in “Surface Active Agents and Detergents”, Vol. I and II, by Schwartz, Perry and Berch.

Suitable anionic surfactants for use in the present invention include water-soluble salts or acids of the formula
ROSO₃M
wherein R is a C₆-C₂₀ linear or branched hydrocarbyl, in another aspect an alkyl or hydroxyalkyl having a C₁₀-C₂₀ alkyl component, and in another aspect a C₁₀-C₁₄ alkyl or hydroxyalkyl; and M is H or a cation, e.g., an alkali metal cation or ammonium or substituted ammonium or sodium.

Other suitable anionic surfactants for use herein are water-soluble salts or acids of the formula
RO(A)ₘSO₃M
wherein R is one embodiment an unsubstituted linear or branched C₆-C₂₀ alkyl or hydroxyalkyl group having a C₁₀-C₂₀ alkyl component, in another embodiment a C₁₂-C₂₀ alkyl or hydroxyalkyl, and in a third embodiment a C₁₂-C₁₄ alkyl or hydroxyalkyl; A is an ethoxy or propoxy unit; m is in one aspect greater than zero, in another aspect between 0.5 and 5, and in even another aspect between 0.5 and 2; and M is H or a cation such as, for example, a metal cation, ammonium or substituted-ammonium cation. Alkyl ethoxylated sulfates as well as alkyl propoxylated sulfates are contemplated herein. Exemplary surfactants are C₁₀-C₁₄ alkyl polyethoxylate (1.0) sulfate, C₁₀-C₁₄ polyethoxylate (1.0) sulfate, C₁₀-C₁₄ alkyl polyethoxylate (2.25) sulfate, C₁₀-C₁₄ polyethoxylate (2.25) sulfate, C₁₀-C₁₄ alkyl polyethoxylate (3.0) sulfate C₁₀-C₁₄ polyethoxylate (3.0) sulfate, and C₁₀-C₁₄ alkyl polyethoxylate (4.0) sulfate, C₁₀-C₁₈ polyethoxylate (4.0) sulfate. In one embodiment the anionic surfactant is a mixture of alkoxylated sulfate surfactants. In another embodiment the anionic surfactant is a mixture of ethoxylated and non-alkoxylated sulfate surfactants. In such an embodiment the average degree of alkoxylation can be from 0.4 to 0.8.

Other suitable anionic surfactants for use herein are alkyl sulfonates, including water-soluble salts or acids of the formula
RSO₃M
wherein R is in one embodiment a C₆-C₂₀ linear or branched, saturated or unsaturated alkyl group, in another embodiment a C₁₀-C₂₀ alkyl group, and in a third embodiment a C₁₀-C₁₄ alkyl group; and M is H or a cation, e.g., an alkali metal cation such as sodium, potassium and lithium or ammonium or substituted ammonium (e.g., methyl-, dimethyl-, and trimethyl ammonium cations and quaternary ammonium cations such as tetramethyl-ammonium and dimethyl piperdinium cations and quaternary ammonium cations derived from alkylamines such as ethylamine, diethylamine, triethylamine and mixtures thereof).

Suitable alkyl aryl sulfonates for use herein include water-soluble salts or acids of the formula
RSO₃M
wherein R is an aryl, preferably a benzyl, substituted by a C₆-C₂₀ linear or branched saturated or unsaturated alkyl group, in another aspect a C₁₂-C₁₆ alkyl group and even another aspect a C₁₀-C₁₄ alkyl group; and M is H or a cation such as an alkali metal cation (e.g., sodium, potassium, lithium, calcium or magnesium) or ammonium or substituted ammonium (e.g., methyl-, dimethyl-, and trimethyl ammonium cations and quaternary ammonium cations such as tetramethyl-ammonium and dimethyl piperdinium cations and quaternary ammonium cations derived from alkylamines such as ethylamine, diethylamine, triethylamine, and mixtures thereof).

In a further embodiment the carbon chain of the anionic surfactant includes alkyl branching units. In one aspect the branching units are C₁-₄ alkyl branching units. In one embodiment the average percentage branching of the anionic surfactant is greater than 30%. In another embodiment the average percentage branching of the anionic surfactant is from 35% to 80%. In even another embodiment the average percentage branching of the anionic surfactant is from 40% to 60%. This average percentage of branching can be achieved by formulating the composition with one or more anionic surfactants which are branched as noted above. Alternatively the composition can include a combination of branched anionic surfactant and linear anionic surfactant such that on average the percentage of branching of the total anionic surfactant combination is greater than 30%. In another embodiment the percentage of branching is from 35% to 80%. In even another embodiment the percentage of branching is from 40% to 60%.

Other anionic surfactants useful for detersive purposes can also be used herein. Examples of these can be found in “Surface Active Agents and Detergents”, Vol. I and II, by Schwartz, Perry and Berch. A variety of such surfactants are also generally disclosed in U.S. Pat. No. 3,929,678 at column 23, line 58 through column 29, line 23.

Other particularly suitable anionic surfactants for use herein include alkyl carboxylates and alkyl alkoxycarboxylates having from 4 to 24 carbon atoms in the alkyl chain. In another aspect these surfactants have from 8 to 18 carbon atoms in the alkyl chain. In even another aspect these surfactants have from 8 to 16 carbon atoms in the alkyl chain. The alkoxy can be propoxy and/or ethoxy. In one embodiment the alkoxy is ethoxy with an alkoxylation degree of from 0.5 to 20. In another embodiment the ethoxy has a degree of alkoxylation of from 5 to 15. The alkyl alkoxycarboxylate for use herein can be a sodium laureth 11 carboxylate (e.g., RO(C₂H₄O)₁₀—CH₂COONa, where R═C₁₂-C₁₄, commercially available under the name Akyposoft RTM 100NV from Kao Chemical Gbmh, Emmerich, Germany).

The particular surfactants used can vary widely depending upon the particular end-use envisioned. One skilled in the art would recognize which surfactant to be used depending on the surface that needs to be cleaned. Furthermore, non-ionic surfactants are not required in order to achieve the synergistic effect described above. Still, non-ionic surfactants can optionally be used in addition to the anionic and/or amphoteric surfactants. Typically, the level of non-ionic surfactant can be less than the anionic surfactant used.

The present invention further relates to a process for cleaning surfaces such as dishware, floors, tiles, kitchen and bathroom surfaces, wood, hair and skin. The surface is contacted with a composition as described above. The composition can be applied to the surface neat or in dilute form, such as in water. Thus the surface can be cleaned singly by applying the composition to the surface and optionally subsequently rinsing the surface, such as with water, before drying. Alternatively, the composition can be mixed with water in a suitable vessel, for example, a basin, sink or bowl thereby allowing a number of surfaces (e.g., dishes) to be cleaned using the same composition and water (dishwater). In a further alternative process the product can be used in dilute form in a suitable vessel as a soaking medium for extremely dirty surfaces. As before, the surface optionally can be rinsed before drying. Drying can take place passively by allowing for the natural evaporation of water or actively using any suitable drying equipment, for example a cloth or towel.

### EXAMPLES

The following examples are presented to further illustrate and explain the present invention and should not be taken as limiting in any regard.

### Example 1

### Preparation of Amphiphilic Polymer Containing 33.3 Mole Percent Acrylic Acid and 66.7 Mole Percent Styrene

An initial charge of 140 g of deionized water and 240 g of isopropyl alcohol was added to a 1 liter glass reactor fitted with a lid having inlet ports for an agitator, water cooled condenser and for the addition of monomer and initiator solutions. The reactor contents were heated to reflux (approximately 86° C.). At reflux, continuous additions of 103 g of acrylic acid, 297 g of styrene and 1 g of dodecylmercaptan (‘DDM’), were added to the reactor concurrently with stirring over a period of 3 hours. During the same time period and for 30 additional minutes the following initiator solutions were added to the reactor:

| Initiator Solution #1 | |
|---|---|
| t-butyl hydroperoxide | 40 g |
| Isopropyl alcohol | 20 g |
| Deionized water | 20 g |
| Initiator Solution # 2 | |
| sodium formaldehyde sulphoxylate | 16 g |
| Deionized water | 80 g |

At the end of the initiator addition, a 47 percent aqueous sodium hydroxide solution (100 g) was added to yield a polymer solution having a final pH of approximately 7 to 8. The reaction temperature was maintained at reflux for a further 1 hour to eliminate any unreacted monomer.

After the 1 hour hold the alcohol cosolvent was removed from the polymer solution by azeotropic distillation under vacuum. During the distillation, deionized water was added to the polymer solution to maintain a reasonable polymer viscosity. The aqueous solution of the amphiphilic copolymer was cooled to less than 30° C.

### Example 2

### Preparation of Amphiphilic Copolymer Containing 60 Mole Percent Acrylic Acid and 40 Mole Percent Styrene

An initial charge of 86.4 g of deionized water, 79.2 g of isopropyl alcohol, and 0.042 grams of ferrous ammonium sulfate were added to a 1 liter glass reactor. The reactor contents were heated to reflux (approximately 84° C.).

At reflux, continuous additions of 64.5 g of acrylic acid, 62.1 g of styrene, 0.1 g of dodecylmercaptan, were added over a period of 3.5 hours. The initiator and chain transfer solutions were added at the same time as the above described monomer solution over a period of 4 hours and 3.25 hours, respectively.

| Initiator solution | | |
|---|---|---|
| Sodium persulfate | 5.72 | g |
| Water | 14.0 | g |
| Hydrogen peroxide 35% | 16.7 | g |
| Chain transfer solution | | |
| 3-mercapto propionic acid, 99.5% | 4.9 | g |
| Water | 21.8 | g |

After adding the initiator and chain transfer solutions, the reaction temperature was maintained at about 88° C. for one hour. The alcohol cosolvent was removed from the polymer solution by azeotropic distillation under vacuum. During the distillation, a mixture of 144 g of deionized water and 64.1 g of a 50 percent sodium hydroxide solution was added to the polymer solution. A small amount of ANTIFOAM 1400 (silicone defoamer commercially available from Dow Coming Corporation, Midland, Mich.) (0.045 g) was added to suppress any foam generated during distillation. Approximately, 190 g of a mixture of water and isopropyl alcohol were distilled off. After distillation was completed, 25 g of water was added to the reaction mixture which was cooled to obtain a yellowish amber solution.

### Example 3

### Preparation of Amphiphilic Copolymer Containing 96.1 Mole Percent Acrylic Acid and 3.9 Mole Percent Lauryl Methacrylate

An initial charge of 190 g of deionized water and 97.1 g of isopropyl alcohol were added to a 1 liter glass reactor. The reactor contents were heated to reflux (approximately 82° C.-84° C.). At reflux continuous additions of 105 g of acrylic acid, and 15.0 g of lauryl methacrylate were added to the reactor concurrently over a 3 hour period of time with stirring. Concurrently, an initiator solution containing 15.9 g of sodium persulfate and 24.0 g of water was added over a period of 4 hours.

The reaction temperature was maintained at 82° C.-85° C. for an additional hour. The alcohol cosolvent was removed from the polymer solution by azeotropic distillation under vacuum. During the half way point of the distillation (occurring when approximately 100 g of distillate was produced), 48 g of hot water was added to the polymer solution to maintain a reasonable polymer viscosity. A small amount of ANTIFOAM 1400 (0.045 g) was added to suppress any foam that may be generated during distillation. Approximately, 200 g of a mixture of water and isopropyl alcohol was distilled off. The distillation was stopped when the isopropyl alcohol level in the reaction product was less than 0.3 weight percent.

The reaction mixture was cooled to less than 40° C. and 45 g of water and 105.8 g of a 50% NaOH was added to the reaction mixture with cooling while maintaining a temperature of less than 40° C. to prevent hydrolysis of the lauryl methacrylate. The final product was an opaque viscous liquid.

### Example 4

### Synthesis of Hydrophobically Modified Polyacrylic Acid with a C₁₂ Chain Transfer Agent

524.8 g of water and 174 g of isopropyl alcohol were heated in a reactor to 85° C. A mixture of 374 g of acrylic acid and 49 g of n-dodecyl mercaptan were added to the reactor over a period of three hours. After addition was completed, 65.3 g of acrylic acid was added over a period of 30 minutes to the reactor. At the same time, a solution of 17.5 g of sodium persulfate in 175 g of water was added to the reactor over a period of four hours. The temperature of the reactor was maintained at 85-95° C. for one hour, after which time, 125 g of water, 51 g of a 50% NaOH solution, and 0.07 g of ANTIFOAM 1400 were added to the reactor. The reaction mixture was distilled to remove the isopropyl alcohol. Approximately 300 g of a mixture of isopropyl alcohol and water were distilled off. The reaction mixture was cooled to room temperature and 388 g of a 50% NaOH solution was added.

### Example 5

### Acrylic Acid Grafted on to a Non-Ionic Surfactant

A polymeric compound was synthesized in the following manner: Five parts of acrylic acid, 3.0 parts of IGEPAL® CO-730 (15 mole ethylene oxide adduct of nonyl phenol nonionic surfactant commercially available from Stepan Company, Northfield, Ill.) and 0.7 parts of sodium hydroxide were dissolved in sufficient water to yield a 100 part aqueous solution. The solution was stirred and heated to 60° C. One part of sodium persulfate was then added thereto. After several minutes an exotherm was apparent with a temperature rise to 75° C. Stirring was continued for 90 minutes while the temperature was maintained at 75° C. The resulting solution was cooled and exhibited a clear, yellowish color and was slightly acidic.

### Example 6

### Preparation of Copolymers Containing a Surfactant Moiety in a Hydrophilic Solvent

In a reactor provided with a stirrer 750 parts by weight deionized water and 250 parts isopropanol were heated to 82° C. A monomer/initiator mixture was made containing 350 parts by weight acrylic acid, 150 parts by weight of an ester of methacrylic acid and a (C₁₆-₁₈) alkoxypoly(ethyleneoxy)ethanol having about twenty ethoxy units, and 8 parts by weight methacrylic acid. Five minutes before the monomer/initiator feed began, 2 parts by weight Lupersol 11 (a/k/a Luperox 11M75, tert-butyl peroxypivalate commercially available from Arkema, Paris, France) were added to the 82° C. isopropanol mixture. The monomer/initiator mixture was then metered in over 2 hours, with the reactor contents kept at 82° C. Thereafter, the reactor contents were heated at 82° C. for a further 30 minutes, then cooled, giving a copolymer dissolved in a water/isopropanol mixed solvent.

### Example 7

### Synthesis of a Monomer with an Unsaturated Alkyl Hydrophobe

79 grams of a methacrylic anhydride was taken in a round bottom flask. To this, 190.7 grams of oleyl amine (70% solution obtained from Aldrich) was added with stirring at room temperature over a period of an hour. The reaction was exothermic and maintained at approximately 25° C. by using a cooling bath. The reaction mixture was allowed to stir for 12 hours. The final product was an opaque yellow solution.

### Example 8

### Synthesis of a Copolymer Incorporating the Monomer Containing an Unsaturated Alkyl Hydrophobe

An initial charge of 200 g of deionized water and 200 g of isopropyl alcohol were added to a 2-liter glass reactor. The reactor contents were heated to reflux (approximately 82° C.-85° C.). At reflux continuous additions of 213 g of acrylic acid, and 16.1 grams of the reaction product of the above Example were added to the reactor concurrently over a 3 hour period of time with stirring. Concurrently, an initiator solution containing 5.0 g of sodium persulfate and 75.0 g of water was added over a period of 4 hours.

The reaction temperature was maintained at 82° C.-85° C. for an additional hour. The alcohol cosolvent was removed from the polymer solution by azeotropic distillation under vacuum. A small amount (0.045 g) of ANTIFOAM 1400 was added to suppress any foam that may be generated during distillation. A solution containing 213.8 grams of 50% NaOH and 200 grams of deionized water was added during the distillation. Approximately, 300 g of a mixture of water and isopropyl alcohol was distilled off. The distillation was stopped when the isopropyl alcohol level in the reaction product was less than 0.3 weight percent. The final product was a clear amber solution.

### Example 9

### Preparation of Amphiphilic Copolymer Containing 49 Mole Percent Acrylic Acid and 51 Mole Percent Styrene

An initial charge of 195.2 g of deionized water, 279.1 g of isopropyl alcohol, and 0.0949 grams of ferrous ammonium sulfate were added to a 1 liter glass reactor. The reactor contents were heated to reflux (approximately 84° C.).

At reflux, continuous additions of 121.4 g of acrylic acid, 175.5 g of styrene, were added over a period of 3.5 hours. The initiator and chain transfer solutions were added at the same time as the above described monomer solution over a period of 4 hours and 3.25 hours, respectively.

| Initiator solution | | |
|---|---|---|
| Sodium persulfate | 12.93 | g |
| Water | 31.6 | g |
| Hydrogen peroxide 35% | 37.8 | g |
| Chain transfer solution | | |
| 3-mercapto propionic acid, 99.5% | 11.1 | g |
| water | 49.3 | g |

After adding the initiator and chain transfer solutions, the reaction temperature was maintained at about 88° C. for one hour. The alcohol cosolvent was removed from the polymer solution by azeotropic distillation under vacuum. During the distillation, a mixture of 325.6 g of deionized water and 134.8 g of a 50 percent sodium hydroxide solution was added to the polymer solution. A small amount of ANTIFOAM 1400 (0.10 g) was added to suppress any foam generated during distillation. Approximately, 375.0 g of a mixture of water and isopropyl alcohol were distilled off. After distillation was completed, 25 g of water was added to the reaction mixture which was cooled to obtain a yellowish amber solution.

### Example 10

Example 9 was repeated using 60 mole percent styrene and 40 mole percent acrylic acid.

An initial charge of 195.2 g of deionized water, 279.1 g of isopropyl alcohol, and 0.0949 grams of ferrous ammonium sulfate were added to a 1 liter glass reactor. The reactor contents were heated to reflux (approximately 84° C.).

At reflux, continuous additions of 97.1 g of acrylic acid, 210.6 g of styrene, were added over a period of 3.5 hours. The initiator and chain transfer solutions were added at the same time as the above described monomer solution over a period of 4 hours and 3.25 hours, respectively.

| Initiator solution | | |
|---|---|---|
| Sodium persulfate | 12.93 | g |
| Water | 31.6 | g |
| Hydrogen peroxide 35% | 37.8 | g |
| Chain transfer solution | | |
| 3-mercapto propionic acid, 99.5% | 11.1 | g |
| water | 49.3 | g |

After adding the initiator and chain transfer solutions, the reaction temperature was maintained at about 88° C. for one hour. The alcohol cosolvent was removed from the polymer solution by azeotropic distillation under vacuum. During the distillation, a mixture of 325.6 g of deionized water and 107.8 g of a 50% sodium hydroxide solution was added to the polymer solution. A small amount of ANTIFOAM 1400 (0.10 g) was added to suppress any foam generated during distillation. Approximately, 375.0 g of a mixture of water and isopropyl alcohol were distilled off. After distillation was completed, 25 g of water was added to the reaction mixture which was cooled to obtain an amber solution.

### Example 11

The compatibility of styrene-acrylate copolymers in alcohol ethoxylate over a 2 month period are detailed below. The polymer solutions were added to the surfactant and stirred thoroughly. They were then observed over a 2 month period.

TABLE 1

| | Wt % | Miscibility | Miscibility |
|---|---|---|---|
| | active | in Tomadol | in Tomadol |
| Polymer | polymer | 25-7* | 25-9* |
| Example 9 | 1 | Very slight ppt | Slight haze |
| | | on bottom | on the bottom |
| Example 9 | 1 | Very compatible | |
| | | even after 3 | |
| | | freeze thaw | |
| | | cycles | |
| Example 9 | 2 | | No ppt, very |
| | | | slight haze |
| Example 9 | 5 | 3 different | Very slight |
| | | samples, two of | ppt at the |
| | | them had a lot of | bottom |
| | | ppt, one had less, | |
| | | very incompatible | |
| Example 10 | 3 | Clear and | |
| | | compatible | |
| Example 10 | 5 | ppt on bottom | |

*Tomadol 25-7 and Tomadol 25-9 are alcohol ethoxylate non-ionic surfactants made from linear C₁₂₋₁₅ alcohol with 7 and 9 moles ethoxylation, respectively, commercially available from Tomah³ Products, Inc., Milton, Wisconsin.

The results were as follows:
(1) The polymer of Example 9 (51 mole % styrene) is more compatible in the Tomadol 25-9 than the Tomadol 25-7.
(2) The polymer of Example 9 (51 mole % styrene) can be added to the Tomadol 25-9 up to 2% active polymer.
(3) The polymer of Example 9 (51 mole % styrene) can be added to the Tomadol 25-9 up to 1% active polymer.
(4) The polymer of Example 10 (60% styrene) is more compatible than the polymer of Example 9 (51 mole % styrene) in 25-7 and can be added to 3% active polymer. Therefore, this exemplifies that the hydrophobicity of the polymer can be matched to the HLB of the surfactant to maximize compatibility.

### Example 12

### Melting Point Reduction

A sample of Tomadol 25-9 was used for testing, which is solid at room temperature. The polymer of Example 9 (51 mole percent styrene) was added to the surfactant at several dosage levels. The samples were first cooled until they began to solidify. They were then heated and the melting point (in BOLD ITALICS type in Table 2 below) was determined as the temperature at which they became completely clear.

TABLE 2

| Sample | Temperature (° F.) | Condition |
|---|---|---|
| Tomadol 25-9 (neat) | 80 | Melting, but hazy |
| | [symbol] | Water clear |
| Tomadol 25-9 + | 72 | Melting |
| 5% polymer of Example 9 | [symbol] | All melted but |
| (51 mole % styrene) | | hazy due to high |
| | | polymer level; |
| | | pink color |
| Tomadol 25-9 + | 73 | Melting but hazy |
| 2% polymer of Example 9 | [symbol] | Clear but slight |
| (51 mole % styrene) | | pink color |
| Tomadol 25-9 + | 73 | Melting |
| 1% polymer of Example 9 | [symbol] | Clear |
| (51 mole % styrene) | | |

The above data indicates that these polymers can be used to lower the melting point of surfactants (versus surfactants without the polymer, or neat), thus making the surfactants easier to process during formulation. The data further indicates that the melting point temperature can be varied based upon the amount of polymer added.

### Example 13

### Additional Testing Completed with Tomadol 25-7

TABLE 3

| Sample | Temperature (° F.) | Condition |
|---|---|---|
| Tomadol 25-7 (neat) | 75 | melted |
| Tomadol 25-7 + | 70 | melted |
| 1% polymer of Example 9 | | |
| (51 mole % styrene) | | |
| Tomadol 25-7 + | 70 | melted |
| 1% polymer of Example 9 | | |
| (51 mole % styrene) | | |
| Tomadol 25-7 + | 58 | melted |
| 5% polymer of Example 10 | | |
| (60% styrene) | | |

The above data indicates that the more compatible the polymer, the more polymer can be added to the surfactant and the lower the melting point will be.

### Example 14

### Preparation of Cationic Copolymer Containing 30 Mole Percent DMAEMA and 70 Mole Percent MMA

To a 2 liter glass vessel equipped with; reflux condenser, stirrer, means of temperature control, 400 g water and 300 g propan-2-ol were charged then heated to a gentle reflux. A monomer mixture of dimethyl aminoethyl methacrylate (106.6 g) and methyl methacrylate (160 g) was fed into the reactor over an approximate timeframe of 3 hours. Sodium persulfate solution (8.7 g in 125 g of water) was fed concurrently with the monomer over a similar time period. When feeds were complete acetic acid solution (36.6 g in 150 g water) was fed into the reactor. A propan-2-ol azeotrope was then distilled from the reactor.

### Example 15

### Non-Ionic Copolymer of N,N-Dimethylacrylamide and Methyl Methacrylate

To a 500 ml glass vessel equipped with; reflux condenser, stirrer, means of temperature control, 200 g water and 100 grams of isopropanol was charged then heated to 85° C. A monomer mixture of N,N-dimethylacrylamide (‘DMAA’) (commercially available from Kohjin, Co., Ltd., Japan) (70.0 g) and methyl methacrylate (30.0 g) was fed into the reactor over an approximate timeframe of 1.25 hours. Sodium persulfate solution (1.0 g in 30 g of water) was fed concurrently with the monomer over 1.5 hours. The reaction mixture was then heated for 2 hours at 85° C. The isopropanol was then distilled to produce a nearly aqueous polymer solution.

### Example 24

100 grams of Neodol® 45-7 (C₁₄₋₁₅ linear alcohol with 7 moles ethoxylation, commercially available from Shell Chemical, Houston, Tex.) was melted by heating to 60° C. 3.3 grams of a 60 percent solution of 2-hydroxylethyl urea from Example 18 was added with stirring. The mixture was maintained at 60° C. for 1 hour. The resultant mixture was a clear homogenous solution with a lower melting point than the starting surfactant.

### Example 25

100 grams of Tomadol 1-9 (C₁₁ alcohol with 9 moles of ethoxylation, available from Tomah³ Products, Inc., Milton, Wis.) were melted by heating to 60° C. 3.3 grams of a 60 percent solution of 2-hydroxylethyl urea from Example 18 was added with stirring. The mixture was maintained at 60° C. for 1 hour. The resultant mixture was a clear homogenous solution with a lower melting point than the starting surfactant.

### Example 26

The interfacial tension of various surfactants in aqueous solution was measured with mineral oil using a spinning drop tensiometer. Typical surfactant concentrations are 100 ppm and the typical polymer concentrations are 5 ppm.

TABLE 4

| | | Interfacial tension |
|---|---|---|
| Surfactant | Polymer | (mN/m) |
| C₁₂H₂₅(OC₂H₄)₂SO₄⁻Na⁺ | None | 24 |
| C₁₂H₂₅(OC₂H₄)₂SO₄⁻Na⁺ | Polymer 9 | 21 |
| Sodium N-lauryl-beta- | None | 6 |
| iminodipropionate | | |
| Sodium N-lauryl-beta- | Polymer 3 | 4.5 |
| iminodipropionate | | |

The above data indicates that due to the reduction in interfacial tension the polymers of this invention will show a synergistic cleaning effect with surfactants in the dilute phase typically encountered in the wash liquor.

### Example 27

### Hand Dishwash Formulation

| | |
|---|---|
| wt % | wt % |

Formulation

| Ingredient | A | B |
|---|---|---|
| Sodium alkane sulfate | 33 | 0 |
| Sodium lauryl ether | 7 | 27 |
| (2 moles) sulfate | | |
| Ethanol | 0 | 7.8 |
| Sodium Cumene sulfonate | 0 | 2.0 |
| C₁₂-C₁₄ amine oxide | 0 | 6.5 |
| C₁₁ alcohol ethoxylate | 0 | 3.0 |
| with 9 EO | | |
| Urea | 3.5 | 0 |
| Polymer of Example 10 | 2 | 0 |
| Polymer of Example 9 | 0 | 2 |
| Water, perfume, colorant | Balance | Balance |

The above formulations are added to the wash liquor at 1 gram of formulation per 1 liter of water. Therefore, the surfactant concentration in the wash liquor is 400 and 365 ppm for formulation A and B respectively. The polymer concentration is 20 ppm in the wash liquor for both formulation A and B.

### Example 28

### Shampoo Formulation

| Ingredient | Wt % |
|---|---|
| Lauryl ether sulfate | 12 |
| Cocoamidopropyl betaine | 3 |
| Monoethanol amide | 1 |
| Polymer of Example 1 | 2 |
| Perfume, water, colorant | Balance |

### Examples 29 and 30

Using the procedure described in Example 1, the following polymers were synthesized.

TABLE 5
Amphiphilic Copolymers

| Example Number | Polymer description | Mole % styrene |
|---|---|---|
| 29 | Acrylic acid-styrene sodium salt | 70 |
| 30 | Acrylic acid-styrene sodium salt | 30 |

### Example 31

The interfacial tension (‘IFT’) of a number of polymer and surfactant compositions against triolein was measured using a spinning drop tensiometer. The surfactants used were a non-ionic alcohol ethoxylate (Neodol® 25-7, available from Shell Chemical, Houston, Tex.), an anionic sodium laureth sulfate surfactant (Steol® CS-230, commercially available from Stepan Company, Northfield, Ill.) and another anionic linear sodium alkylbenzene sulfonate (Bio-Soft® D-40, available from Stepan Company, Northfield, Ill.). The total surfactant concentration was 200 ppm, and the polymer concentration was 20 ppm. The test was conducted at 35° C. using a hardness level of 51 ppm. IFT is measured in mN/m and SD is the standard deviation in the measurement.

TABLE 6
Interfacial tension measurements of polymers
and individual surfactants with triolein

| | |
|---|---|
| Neodol ® 25-7 | Steol ® CS-230 |

| | IFT, | | IFT, | |
|---|---|---|---|---|
| | mN/m | SD | mN/m | SD |
| No polymer | 2.22089 | 0.14025 | 0.00459 | 0.00120 |
| Example 9 | 2.68311 | 0.06069 | 0.00074 | 0.00006 |
| Example 10 | 2.63401 | 0.02600 | 0.00082 | 0.00013 |
| Example 1 | 2.36463 | 0.08790 | 0.00486 | 0.00068 |
| Example 29 | 2.45037 | 0.09477 | 0.00153 | 0.00043 |
| Example 2 | 2.33549 | 0.49117 | 0.00415 | 0.00065 |
| Example 30 | 2.15234 | 0.15986 | 0.00091 | 0.00012 |

The data in Table 1 indicate that the polymers of this invention are effective in reducing the IFT's of an anionic surfactant (here, Steol® CS-230). However, they have no effect on the IFT's of a non-ionic surfactant (here, Neodol® 25-7).

TABLE 7
Interfacial tension measurements of
polymers and surfactant mixtures with triolein

| | |
|---|---|
| 1/1/1 ratio* | 1/1/4 ratio |

| | IFT, mN/m | SD | IFT, N/m | SD |
|---|---|---|---|---|
| No polymer | 0.60910 | 0.03660 | 0.11361 | 0.00369 |
| Example 9 | 0.55821 | 0.01937 | 0.13720 | 0.00972 |
| Example 10 | 0.47359 | 0.00492 | 0.13008 | 0.02755 |
| Example 1 | 0.45497 | 0.00831 | 0.08298 | 0.00013 |
| Example 29 | 0.61262 | 0.01533 | 0.12662 | 0.00071 |
| Example 2 | 0.54217 | 0.01109 | 0.12379 | 0.02432 |
| Example 30 | 0.40526 | 0.00505 | 0.08785 | 0.00189 |

*1/1/1 indicates a 1:1:1 weight ratio of Neodol ® 25-7:Bio-Soft ® D-40:Steol ® CS-230. 1/1/4 indicates a 1:1:4 weight ratio of Neodol ® 25-7:Bio-Soft ® D-40:Steol ® CS-230.

The data in Table 2 indicate that the polymers of this invention are effective at reducing the IFT's of a mix of anionic and non-ionic surfactant used in commercial formulations. However, as seen from the last two columns, the greater the weight fraction of the anionic surfactant, the greater the ability of the polymer to reduce the IFT's. The reduction in IFT's is directly related to cleaning oil soils (here, triolein), i.e., the lower the IFT, the better the oily soil cleaning.

### Example 32

### Hand Dishwash Formulation

| | |
|---|---|
| wt % | wt % |

Formulation

| Ingredient | A | B |
|---|---|---|
| Sodium lauryl ether | 27 | 27 |
| (0.6 moles) sulfate | | |
| Ethanol | 7.8 | 7.8 |
| Sodium Cumene sulfonate | 2.0 | 2.0 |
| C₁₂-C₁₄ amine oxide | 6.5 | 6.5 |
| C₁₁ alcohol ethoxylate | 3.0 | 3.0 |
| with 9 EO | | |
| Polymer of Example 2 | 2 | 0 |
| Water, perfume, colorant | Balance | Balance |

Formulations A and B were diluted down to end use levels. Formulation A with the polymer 2 of this invention dissolved faster than the same formulation without the polymer (Formulation B).

### Example 33

### Shower Gel/Bath Formulation

Formulation

| | Wt % | Wt % |
|---|---|---|
| Ingredient | A | B |
| Sodium isethionate | 9 | 5 |
| Lauryl ether sulfate | 0 | 2 |
| Cocoamidopropyl betaines | 6 | 8 |
| Silicone oil | 5 | 5 |
| Polymer of Example 4 | 1 | 0 |
| Polymer of Example 5 | 0 | 1 |
| Perfume, water, colorant | Balance | Balance |

The formulation is diluted down during end use. The surfactant and polymer concentration in the end use dilute form of these formulations are typically less than 100 ppm.

Although the present invention has been described and illustrated in detail, it is to be understood that the same is by way of illustration and example only, and is not to be taken as a limitation. The spirit and scope of the present invention are to be limited only by the terms of any claims presented hereafter.

1. A surfactant blend useful in cleaning compositions comprising:
at least one amphoteric and/or anionic surfactant; and
from 0.1 to 10 percent by weight of at least one amphiphilic copolymer based on the weight of the surfactant;
wherein the at least one amphiphilic copolymer has a synergistic cleaning effect with the at least one anionic and/or amphoteric surfactants.

2. A concentrated surfactant composition comprising at least 50 percent by weight of the surfactant blend of claim 1.

3. The concentrated surfactant composition of claim 2 comprising at least 60 percent by weight of the surfactant blend.

4. The surfactant blend of claim 1 wherein the amphiphilic copolymer is provided in an amount of from 0.5 to 5 percent by weight of based on the weight of the surfactant.

5. The surfactant blend of claim 1 wherein said amphiphilic copolymer comprises a hydrophilic backbone and at least one hydrophobic moiety.

6. The amphiphilic copolymer of claim 5 wherein said hydrophilic backbone comprises monomer units selected from the group consisting of acrylic acid, methacrylic acid, maleic acid, maleic anhydride, itaconic acid, and mixtures thereof.

7. The amphiphilic copolymer of claim 5 wherein said hydrophobic moiety is one or more hydrophobic monomers selected from the group consisting of acrylate monomers, methacrylate monomers, styrene and styrene derivatives, acrylamide derivatives and alkyl acrylamide, vinyl naphthalene, and butadiene.

8. The amphiphilic copolymer of claim 5 wherein said hydrophobic moiety comprises a chain transfer agent.

9. The surfactant blend of claim 1 wherein said surfactant further comprises at least one non-ionic surfactant.

10. The non-ionic surfactant of claim 9 wherein the non-ionic surfactant is selected from the group consisting of alcohol ethoxylates, nonophenol ethoxylates and mixtures thereof.

11. The surfactant blend of claim 1 wherein said surfactant comprises an anionic surfactant.

12. The anionic surfactant of claim 11 wherein the anionic surfactant is selected from the group consisting of linear alkyl benzene sulfonates, alcohol ether sulfates and mixtures thereof.

13. The surfactant blend of claim 1 wherein said blend comprises one or more non-ionic surfactants and one or more anionic surfactants.

14. A method of cleaning surfaces comprising the step of:
contacting the surface to be cleaned with a solution having
less than 1000 ppm of at least one amphiphilic copolymer formed from polymerizing at least one hydrophilic acid monomer and at least one hydrophobic moiety, and
less than 1000 ppm of at least one amphoteric and/or at least one anionic surfactant, and
optionally rinsing the surface with water such that the surface is cleaned.

15. The method of cleaning surfaces according to claim 14 wherein the surface is dishware, floor, tiles, kitchen and bathroom surfaces, wood, hair or skin.

16. The method of cleaning surfaces according to claim 14 wherein the surfactant is an amine oxide surfactant.

17. The method of cleaning surfaces according to claim 14 wherein the surfactant is an alcohol ether sulfate.

18. The method of cleaning surfaces according to claim 14 wherein the hydrophobic moiety is chosen from lauryl methacrylate, methyl methacrylate and styrene.

19. The method of cleaning surfaces according to claim 14 wherein the hydrophilic moiety is chosen from acrylic acid, methacrylic acid, maleic acid, itaconic acid, sodium methallyl sulfonate, sodium allyloxybenzene sulfonate and sodium acrylamidomethyl propane sulfonate.

20. The method of cleaning surfaces according to claim 14 wherein the hydrophobic moiety is a C₃ to C₂₄ chain transfer agent.

21. A method for improving the solubility of a hand dishwashing composition, the method comprising:
adding an amphiphilic copolymer a hydrophilic backbone and at least one hydrophobic moiety to a hand dishwashing composition, and
diluting the hand dishwashing composition.

22. The method of claim 21 where the hand dishwash formulation further comprises one or more anionic or amphoteric surfactants or mixtures thereof.

23. The method of claim 22 where the surfactant is an anionic surfactant and the anionic surfactant is an alcohol ether sulfate.

24. The method of claim 22 where the surfactant is an amphoteric surfactant and the amphoteric surfactant is an amine oxide.
